(19) United States
(12) Patent Application Publication
(10) Pub. No.: US 2002/0157517 A1
(43) Pub. Date: Oct. 31, 2002

(54) Paper punch

(76) Inventor: Chien Kai Huang, Chang Hua City (TW)

Correspondence Address: BACON & THOMAS, PLLC, 4th Floor, 625 Slaters Lane, Alexandria, VA, 22314-1176, US

(21) Appl. No.: 09/842,720

(22) Filed: Apr. 27, 2001

(51) Int. Cl. B26F 1/02

(52) U.S. Cl. 83/618; 83/628; 83/687; 83/588; 83/699.31; 83/167

(57) ABSTRACT

A paper punch includes a base having two lugs on a top of the base and a push arm is pivotally connected between the two lugs. A support plate is connected to the base and a plurality of punching assemblies are connected to the support plate. The base has holes defined through the top thereof and a flange extends from an underside of the top of the base and encloses each of the holes. The top of the base is reinforced by the flanges so as to avoid from being deformed.

### FIELD OF THE INVENTION

The present invention relates to a paper or document punch that has a reinforced base to avoid from deformation. Each hole in the base is defined by a flange which reinforces the structural strength of the base.

### BACKGROUND OF THE INVENTION

A conventional document punch is shown in FIGS. 5 and 6 and generally includes a base 70 in which a collection box 73 is slidably received. Two lugs 72 extend from a top 71 of the base 70 and a push arm 50 is pivotally connected between the two lugs 72. A support plate 65 is welded on the base 70 and a punch assembly 60 is fixedly connected to the support plate 65 by a bolt 64. The punch assembly 60 includes a tubular knife 61 with a spring 62 mounted thereon and the spring 62 is restrained in a frame 66. A slit 63 is defined between the frame 66 and the top 71 of the base 70 so as to receive papers therein. A hole 711 is defined through the top 71 of the base 70 and located in alignment with the knife 61. When pushing the push arm 50 downward to lower the knife 61, the paper 80 in the slit 63 is penetrated by the knife 61 and the debris 800 of the paper 80 is collected in the collection box 73. The pressure applied onto the top 71 of the base 70 when punching holes in the paper 80 is large so that the top 71 will be deformed. In order to strengthen the structural strength of the base 70, some manufacturers increase the thickness of the base 70 and this increase the inconvenience of carriage and/or transportation.

### SUMMARY OF THE INVENTION

In accordance with one aspect of the present invention, there is provided a paper punch and comprises a base having holes defined through a top of the base and a collection box is slidably mounted to the base. Two lugs extend from the top of the base and a push arm is pivotally connected between the two lugs. A flange extends from an underside of the top of the base and encloses each of the holes. A support plate is connected on the top of the base and a plurality of punching assemblies are connected to the support plate.

The primary object of the present invention is to provide a paper punch that has a reinforcement top so as to prevent from being deformed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a paper punch of the present invention;

FIG. 2 is a cross sectional view to show the paper punch of the present invention;

FIG. 3 is a cross sectional view to show the paper punch of the present invention wherein the push arm is pivoted;

FIG. 4 is a side view to show the paper punch of the present invention when the push arm is pivoted;

FIG. 5 is a cross sectional view to show a conventional paper punch, and

FIG. 6 is a cross sectional view to show the conventional paper punch wherein the push arm is pivoted.

### DETAILED DESCRIPTION OF THE PREFERRED EMBODIMENT

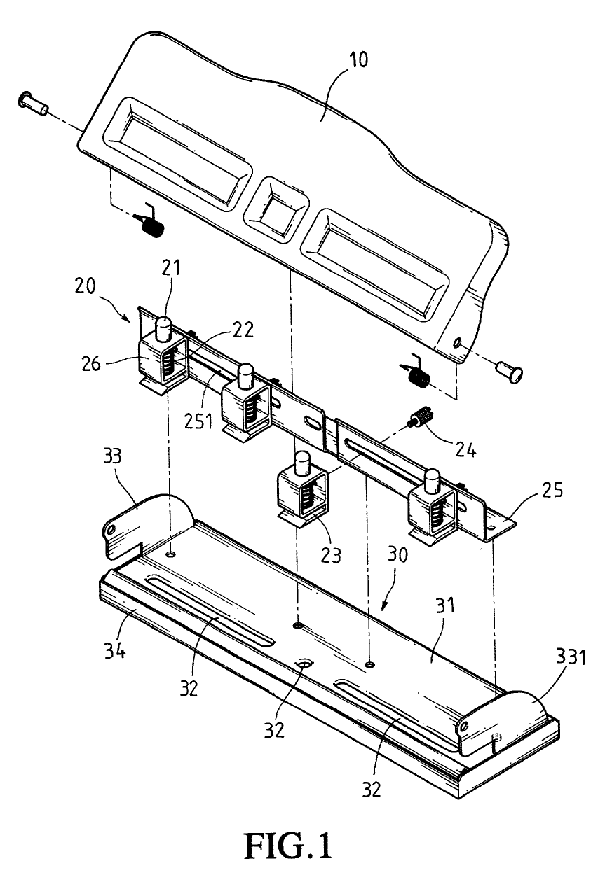

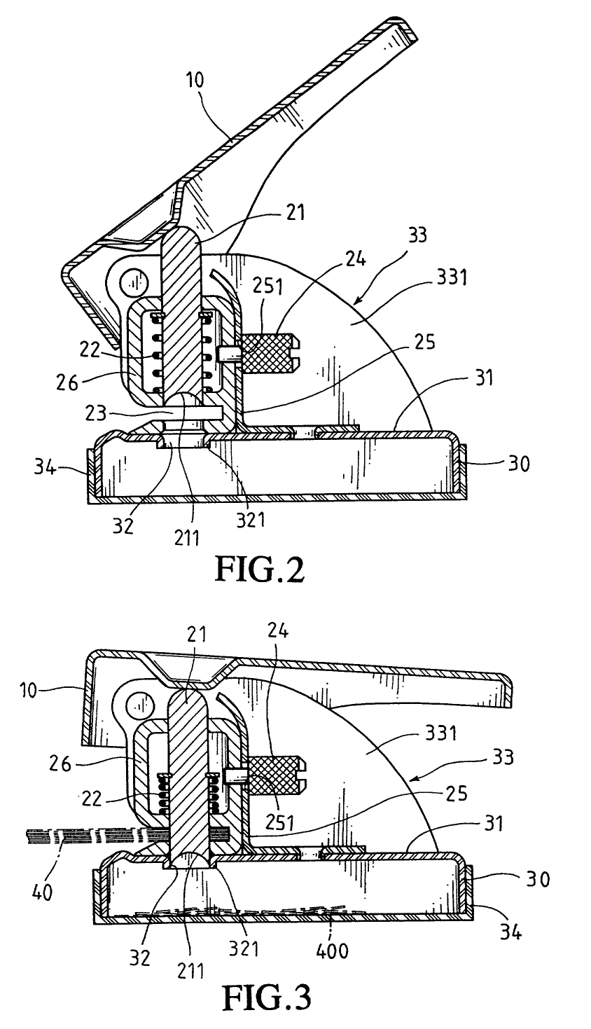

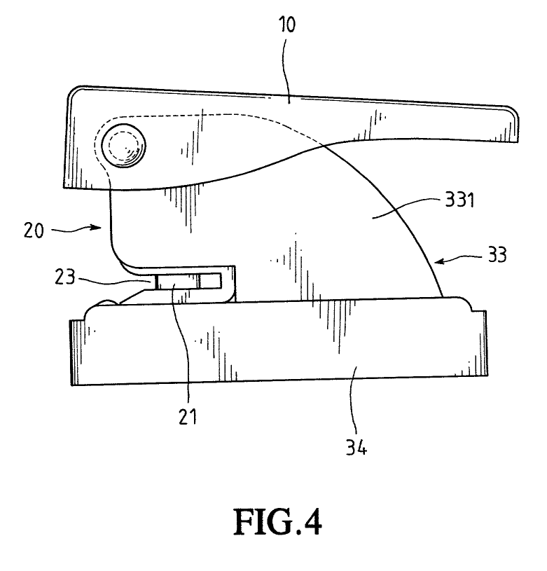

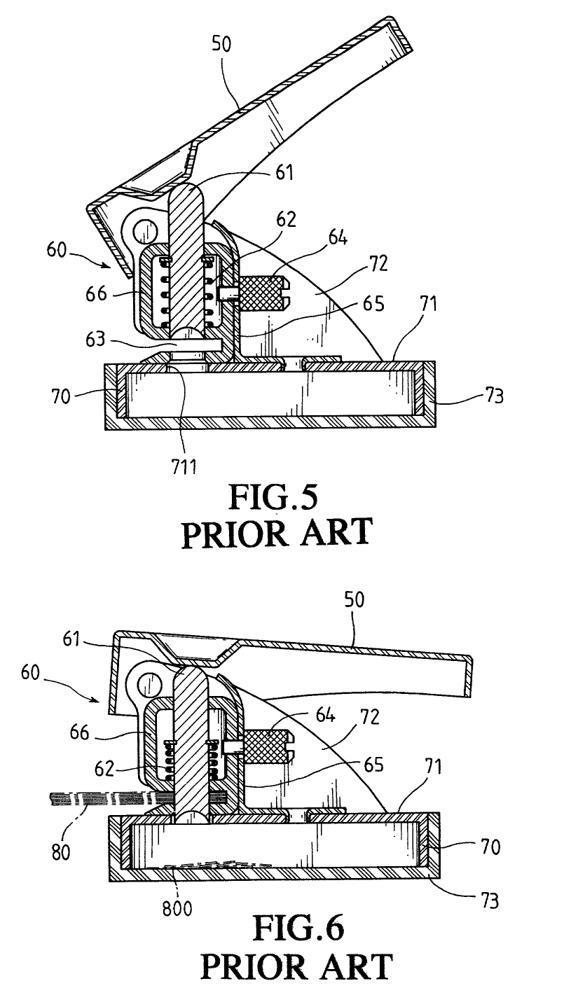

Referring to FIGS. 1 and 2, the paper punch of the present invention comprises a base 30 having holes 32 defined through a top 31 of the base 30 and a flange 321 extends from an underside of the top 31 of the base 30 and encloses each of the holes 32. A collection box 34 is slidably mounted to the base 30. Two lugs 33 extend from the top 31 of the base 30 and a push arm 10 is pivotally connected between the two lugs 33. The two lugs 33 are located on two ends of the top 31 of the base 30 and an end 331 of each of the lugs 33 extends from a rear edge of the base 30, as shown in FIG. 4. The width of the end 331 of each of the two lugs 33 increases the length of the connection between the lugs 33 and the top 31 of the base 30 so as to reinforce the structural strength of the base 30. A free end of each of the lugs 33 is located close to a front edge of the base 30.

An L-shaped support plate 25 are connected on the top 31 of the base 30 and has two slots 251 defined through an upright portion thereof. A plurality of punching assemblies 20 are connected to the upright portions of the support plate 25. Each punching assembly 20 has a rectangular frame 26 with a tubular knife 21 movably extending therethrough. A spring 22 is mounted to the tubular knife 21 and biased between a top and a bottom of the frame 26. Each of the punch assemblies 20 is slidably positioned on the support plate 25 by extending bolts 24 through the slots 251 and connected to the frames 26. A slit 23 is defined between the top 31 of the base 30 and the lower end 211 of the tubular knife 21. The holes 32 are located in alignment with the tubular knifes 21. The top of each of the tubular knifes 21 contacts an underside of the push arm 10 so that when the push arm 10 is pivoted toward the base 30, the tubular knifes 21 are lowered to penetrate paper 40 received in the slits 23 as shown in FIG. 3. The debris 400 of the paper 40 generated by the punching action is collected in the collection box 34.

It is to be noted that the flanges 321 reinforce the structural strength of the top 31 of the base 30 so that the periphery of each of the holes 32 will not be deformed. The flange 321 can be easily made during pressing the holes 32 in the top 31 of the base 30 and the flange 321 is made by bending the material of the top 31 along the periphery of the holes 32. The type of the flanges 321 can be made by different way or can be different shapes as long as the flange 321 reinforces the periphery of the holes 32. The end 331 of each of the lugs 33 begins from a rear edge of the base 30 and the width of the end 331 effectively increases the length of the connection between the lugs 33 and the top 31 of the base 30 so that the base 30 does not tend to be deformed.

While we have shown and described the embodiment in accordance with the present invention, it should be clear to those skilled in the art that further embodiments may be made without departing from the scope of the present invention.

What is claimed is:

1. A paper punch comprising:
a base having holes defined through a top of said base and a collection box slidably mounted to said base, two lugs extending from said top of said base, a flange extending from an underside of said top of said base and enclosing each of said holes;
a support plate connected on said top of said base and a plurality of punching assemblies connected to said support plate, each punching assembly having a frame with a tubular knife movably extending therethrough, a spring mounted to said tubular knife and biased between a top and a bottom of said frame, a slit defined between said top of said base and said lower end of said tubular knife, said holes located in alignment with said tubular knifes, and
a push arm pivotally connected between said two lugs so as to push said tubular knifes toward said base.

2. The paper punch as claimed in claim 1, wherein said support plate has a slot and said frames are connected to said support plate by extending bolts through said slots and connected to said frames.
